(19) United States
(12) Patent Application Publication
(10) Pub. No.: US 2015/0062012 A1
(43) Pub. Date: Mar. 5, 2015

(54) DISPLAY CONTROL APPARATUS, DISPLAY CONTROL METHOD, DISPLAY CONTROL SIGNAL GENERATING APPARATUS, DISPLAY CONTROL SIGNAL GENERATING METHOD, PROGRAM, AND DISPLAY CONTROL SYSTEM

(71) Applicant: SONY CORPORATION, Tokyo (JP)

(72) Inventors: IKUO YAMANO, TOKYO (JP); KUNIHITO SAWAI, KANAGAWA (JP); YUHEI TAKI, KANAGAWA (JP); HIROYUKI MIZUNUMA, TOKYO (JP); YUSUKE NAKAGAWA, TOKYO (JP); KEISUKE YAMAOKA, TOKYO (JP)

(21) Appl. No.: 14/468,562

(22) Filed: Aug. 26, 2014

(30) Foreign Application Priority Data
Sep. 4, 2013 (JP) 2013-182740

(51) Int. Cl. G06F 3/0354; G06F 3/0484

(52) U.S. Cl. CPC G06F 3/0354; G06F 3/04842; G06F 3/04845
USPC 345/158

(57) ABSTRACT

There is provided a display control apparatus including a display control unit configured to move an object displayed on a display unit in accordance with a change amount of an indicated direction of a direction indicator. The display control unit changes a movement amount of the object corresponding to the change amount on the basis of a rotational angle with the indicated direction used as an axis.

### CROSS REFERENCE TO RELATED APPLICATIONS

This application claims the benefit of Japanese Priority Patent Application JP 2013-182740 filed Sep. 4, 2013, the entire contents of which are incorporated herein by reference.

### BACKGROUND

The present disclosure relates to a display control apparatus, a display control method, a display control signal generating apparatus, a display control signal generating method, a program, and a display control system.

Operation terminals having a remote controller function are used today to externally operate a variety of information processing apparatuses such as television receivers and personal computers (PCs). As the functions of information processing apparatuses grow diverse, more and more operation terminals have various operations performed on the screen. One of such operation terminals is equipped with a motion sensor, and, on the basis of a direction of the operation terminal, the operation terminal performs various processing such as displaying a cursor, moving focus, and selecting/deciding an image and text at the corresponding position.

An operation terminal equipped with a motion sensor detects a movement of a hand and arm of a user who grasps the operation terminal, and performs various processing. The operation terminal sometimes detects even an unintentional movement of a user's hand, which unfortunately makes the operation unstable. Accordingly, such technology is desired that reduces the influence of an unintentional movement of a user's hand to enhance the operability.

For example, WO 2009/072475 discloses a technique for correcting the coordinate values of a pointer from the time a user starts to press a button to the time the button is turned on, on the basis of an extent to which the button is pushed down, in order to prevent an image of the pointer from moving by accident.

### SUMMARY

The technique disclosed in WO 2009/072475, however, is not capable of preventing an accidental movement caused by a preliminary operation in which a user starts to press a button and it is detected that the user has started to press the button. The technique disclosed in WO 2009/072475 is capable of preventing no movement but the accidental movement caused when the button is pressed. In view of such circumstances, the further improved technique is desired that prevents an unintentional movement of a user's hand to enhance the operability.

The present disclosure proposes a novel and improved display control apparatus, display control method, display control signal generating apparatus, display control signal generating method, program, and display control system that can reduce an accidental movement caused by an unintentional movement of a user's hand to enhance the operability.

According to an embodiment of the present disclosure, there is provided a display control apparatus including a display control unit configured to move an object displayed on a display unit in accordance with a change amount of an indicated direction of a direction indicator. The display control unit changes a movement amount of the object corresponding to the change amount on the basis of a rotational angle with the indicated direction used as an axis.

According to another embodiment of the present disclosure, there is provided a display control method including changing, on the basis of a rotational angle with an indicated direction of a direction indicator used as an axis, a movement amount of an object displayed on a display unit corresponding to a change amount of the indicated direction, and moving the object in accordance with the change amount.

According to still another embodiment of the present disclosure, there is provided a program for causing a computer to execute changing, on the basis of a rotational angle with an indicated direction of a direction indicator used as an axis, a movement amount of an object displayed on a display unit corresponding to a change amount of the indicated direction, and moving the object in accordance with the change amount.

According to yet another embodiment of the present disclosure, there is provided a display control signal generating apparatus including a detection unit configured to detect a change amount of an indicated direction and a rotational angle with the indicated direction used as an axis, and a generation unit configured to generate a display control signal for moving an object displayed on a display unit in accordance with the change amount detected by the detection unit. The generation unit generates the display control signal in which a movement amount of the object corresponding to the change amount is changed on the basis of the rotational angle detected by the detection unit.

Further, according to an embodiment of the present disclosure, there is provided a display control signal generating method including detecting a change amount of an indicated direction and a rotational angle with the indicated direction used as an axis, and generating a display control signal for moving an object displayed on a display unit in accordance the detected change amount, in which a movement amount of the object corresponding to the change amount is changed on the basis of the detected rotational angle.

Still further, according to an embodiment of the present disclosure, there is provided a program for causing a computer to execute detecting a change amount of an indicated direction and a rotational angle with the indicated direction used as an axis, and generating a display control signal for moving an object displayed on a display unit in accordance the detected change amount, in which a movement amount of the object corresponding to the change amount is changed on the basis of the detected rotational angle.

Yet further, according to an embodiment of the present disclosure, there is provided a display control system including a detection unit configured to detect a change amount of an indicated direction and a rotational angle with the indicated direction used as an axis, and a display control unit configured to move an object displayed on a display unit in accordance with the change amount detected by the detection unit. The display control unit changes a movement amount of the object corresponding to the change amount on the basis of the rotational angle with the indicated direction used as an axis.

According to one or more of embodiments of the present disclosure, it is possible to reduce an accidental movement caused by an unintentional movement of a user's hand to enhance the operability.

### BRIEF DESCRIPTION OF THE DRAWINGS

FIG. 1 is an explanatory diagram illustrating an overview of a display control system according to an embodiment of the present disclosure;

FIG. 2 is an explanatory diagram illustrating an overview of a display control system according to an embodiment of the present disclosure;

FIG. 3 is a block diagram illustrating a configuration of a display control system according to a first embodiment;

FIG. 4 is an explanatory diagram illustrating a relationship between a roll angle and a speed gain in display control processing according to the first embodiment;

FIG. 5 is an explanatory diagram illustrating the relationship between the roll angle and the speed gain in the display control processing according to the first embodiment;

FIG. 6 is a sequence diagram illustrating an operation of the display control system according to the first embodiment;

FIG. 7 is a diagram for describing an advantageous effect of the display control system according to the first embodiment;

FIG. 8 is a diagram for describing an advantageous effect of the display control system according to the first embodiment;

FIG. 9 is a diagram for describing a display control system according to a modified example 1;

FIG. 10 is a diagram for describing a display control system according to a modified example 2;

FIG. 11 is a diagram for describing the display control system according to the modified example 2;

FIG. 12 is a block diagram illustrating a configuration of a display control system according to a second embodiment; and

FIG. 13 is a sequence diagram illustrating an operation of the display control system according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Overview of Display Control Processing according to Embodiment of Present Disclosure

### 2. Embodiments

2-1. First Embodiment
2-1-1. Configuration
2-1-2. Operational Processing
2-1-3. Advantageous Effects
2-1-4. Modified Example 1
2-1-5. Modified Example 2

2-2. Second Embodiment
2-2-1. Configuration
2-2-2. Operational Processing

### 3. Conclusion

### 1. OVERVIEW OF DISPLAY CONTROL PROCESSING ACCORDING TO EMBODIMENT OF PRESENT DISCLOSURE

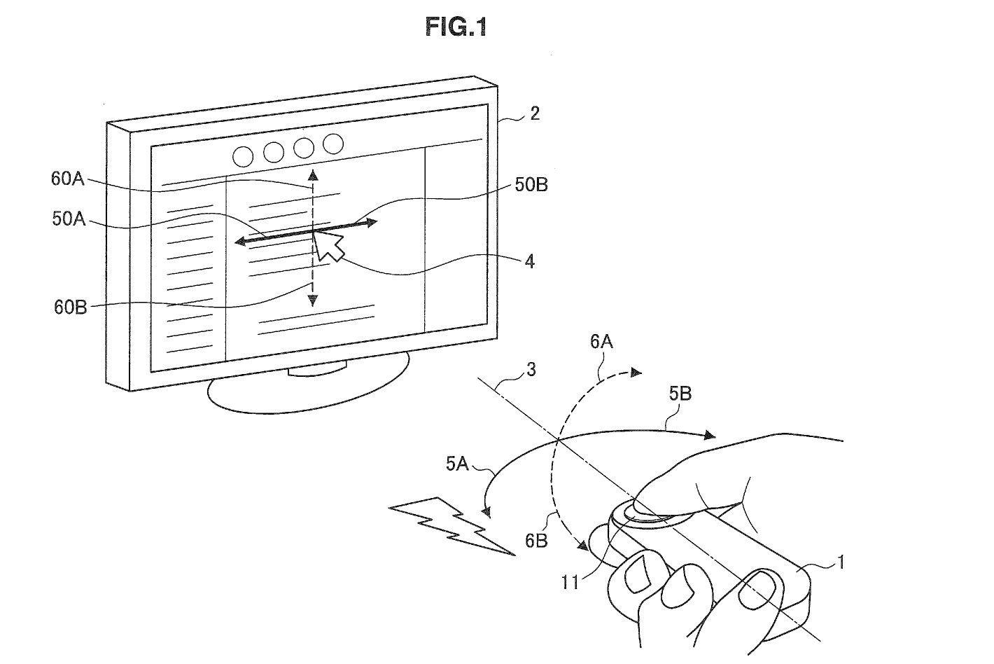

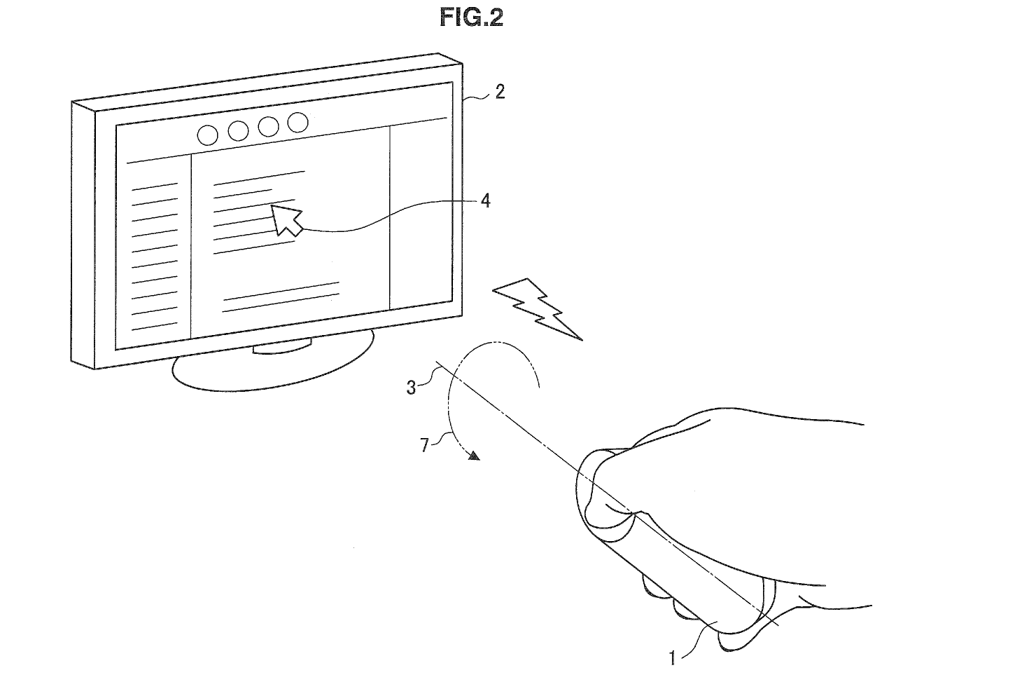

An overview of display control processing according to an embodiment of the present disclosure will be now described with reference to FIGS. 1 and 2.

FIG. 1 is an explanatory diagram illustrating an overview of a display control system according to an embodiment of the present disclosure. FIG. 1 shows that the display control system according to the embodiment of the present disclosure includes an operation terminal 1 and a display apparatus 2, and performs display control processing. The display control system according to the present embodiment does not absolutely detect a direction of the operation terminal 1 to control display, but estimates the direction on the basis of a detection result from a sensor built in the operation terminal 1 to perform display control processing.

The operation terminal 1 is operated by a user, detects the inclination or the movement with an accelerator sensor or a gyro sensor, and transmits the detection result to the display apparatus 2. The display apparatus 2 estimates an indicated direction 3, which is a direction of the operation terminal 1, on the basis of the detection result from the operation terminal 1, and displays the screen based on the estimated indicated direction 3.

More specifically, FIG. 1 shows that the display apparatus 2 displays a cursor 4 (object) at the position corresponding to the indicated direction 3 of the operation terminal 1 on the basis of the detection result received from the operation terminal 1. Once a user moves the operation terminal 1 in a yaw direction 5A with respect to the ground, the display apparatus 2 moves the cursor 4 in an X direction 50A. Meanwhile, once a user moves the operation terminal 1 in the opposite yaw direction 5B, the display apparatus 2 moves the cursor 4 in the X direction 50B. Likewise, once a user moves the operation terminal 1 in a pitch direction 6A with respect to the ground, the display apparatus 2 moves the cursor 4 in a Y direction 60A. Once a user moves the operation terminal 1 in the opposite pitch direction 6B, the display apparatus 2 moves the cursor 4 in the Y direction 60B. A user moves the operation terminal 1 in this way, so that the user can move the cursor 4 at will in the corresponding direction. A user operates an operation unit 11 including a decision button to operate an image, text, or a button displayed on a screen in a desired manner. When the yaw directions 5A and 5B do not have to be particularly distinguished, a generic term yaw direction 5 will be used below. Likewise, the pitch directions 6A and 6B are generically referred to as pitch direction 6. The X directions 50A and 50B are generically referred to as X direction 50, while the Y directions 60A and 60B are generically referred to as Y direction 60.

FIG. 2 shows that the operation terminal 1 can detect the rotation in a roll direction 7 with respect to the ground. FIG. 2 is an explanatory diagram illustrating an overview of a display control system according to an embodiment of the present disclosure. Generally speaking, even though a user rotates the operation terminal 1 in the roll direction 7 with respect to the ground, the movement is not reflected in a movement of the cursor 4. This is because the cursor 4 on a screen moves on a two-dimensional plane, but the angle of the axis orthogonal to the screen plane indicated by the cursor 4 itself does not change. This allows the display control system to move the cursor 4 in the X direction 50 whenever the operation terminal 1 moves in the yaw direction 5 with respect to the ground, regardless of a postural angle in the roll direction 7 with respect to the indicated direction 3 at which the operation terminal 1 is grasped by a user. Accordingly, for example, even while a user is operating the operation terminal 1 in a lying state, the user can intuitively move the cursor 4 without taking account of the postural angle of the operation terminal 1 in the roll direction 7.

A movement of a user can be directly reflected in a movement of the cursor 4 in the display control method described so far. Accordingly, the method is cut out for a dynamic operation that the cursor 4 moves on a screen from edge to edge. However, it is unfortunately difficult to point a small object on a screen. For example, when a user tries to select a small object such as a text link on an Internet browser, an unintentional movement of the user's hand is sometimes reflected in a movement of the cursor 4 and makes the movement of the cursor 4 unstable. Accordingly, a user has to bear more burdens for the pointing operation.

More and more people are today operating Internet browsers with television receivers. Thus, it is desired to enable a user to easily point a small object while the user dynamically moves the cursor 4 on a wide screen.

In order to reduce the difficulty of pointing a small object, it is proposed to use a mechanism of a variable speed gain, which is commonly known as an operation of a PC mouse such as slowing a movement of the cursor 4 when a movement of the operation terminal 1 is also slow. Such processing, however, causes a more frequent gap between a direction of the operation terminal 1 and a position of the cursor 4 on the screen, resulting in the reduced pointing operability.

When the operation unit 11 is a device such as a button that is perpendicularly pushed down and the button is pushed down as a user horizontally keeps the plane of the operation unit 11 on which the operation unit 11 is installed, the pushing operation moves the operation unit 11 in the pitch direction 6. This movement also moves the cursor 4 in the Y direction 60. Accordingly, when an object is short in the Y direction 60 like a text link, the accidental movement caused by the operation of pushing the button down moves the cursor 4 out of the object range and sometimes leads to the failure in the deciding operation. Usually speaking, the decision button is structured like a simple switch. The accidental movement of the cursor 4 caused when a decision is made is also starting to occur in a preliminary operation in which the button has not yet been pushed down. The technique disclosed in WO 2009/072475 prevents the accidental movement on the basis of an extent to which the button is pushed down, so that it is difficult to predict and prevent an accidental movement caused by the preliminary operation, which is not represented by the extent to which the button is pushed down.

In view of such circumstances, the display control processing according to embodiments of the present disclosure is proposed. The display control processing according to each embodiment of the present disclosure allows a user to easily change a speed gain, thereby reducing an accidental movement caused by an unintentional movement of the user's hand and enhancing the operability. Additionally, the speed gain represents a ratio of a movement of the cursor 4 to a change in a postural angle of the operation terminal 1 in the pitch direction 6 and the yaw direction 5.

More specifically, the operation terminal 1 changes the speed gain in accordance with the postural angle in the roll direction 7. The operation terminal 1 lowers the speed gain, for example, when the operation terminal 1 is rotated by a predetermined angle or more from the initial state. A user can lower the speed gain by twirling the operation terminal 1 with a wrist motion.

Once the speed gain is reduced, a movement amount of the cursor 4 that responds to a movement of the operation terminal 1 is lowered. Accordingly, an amount of an accidental movement corresponding to an unintentional operation such as a movement of a hand is also reduced. Thus, a user can easily point a small object. Even if a hand moves for pushing a button down, the movement amount is so small that an object range is not exceeded, which prevents the failure in the deciding operation.

However, when the speed gain is lowered, a movement amount resulting from an operation intended by a user also grows smaller. Thus, a user roughly brings the cursor 4 near an object, and then adjusts the speed gain to decide the final position. This allows the user to easily point a small object while dynamically moving the cursor 4 on a wide screen.

Even though the speed gain is adjusted by such a twirling operation, there may be a gap between a direction of the operation terminal 1 and a position of the cursor 4 on a screen, as with an approach that uses the mechanism of a variable speed gain. However, a user roughly brings the cursor 4 to an object, and then adjusts the speed gain to decide the final position. Accordingly, the positional gap has little influence.

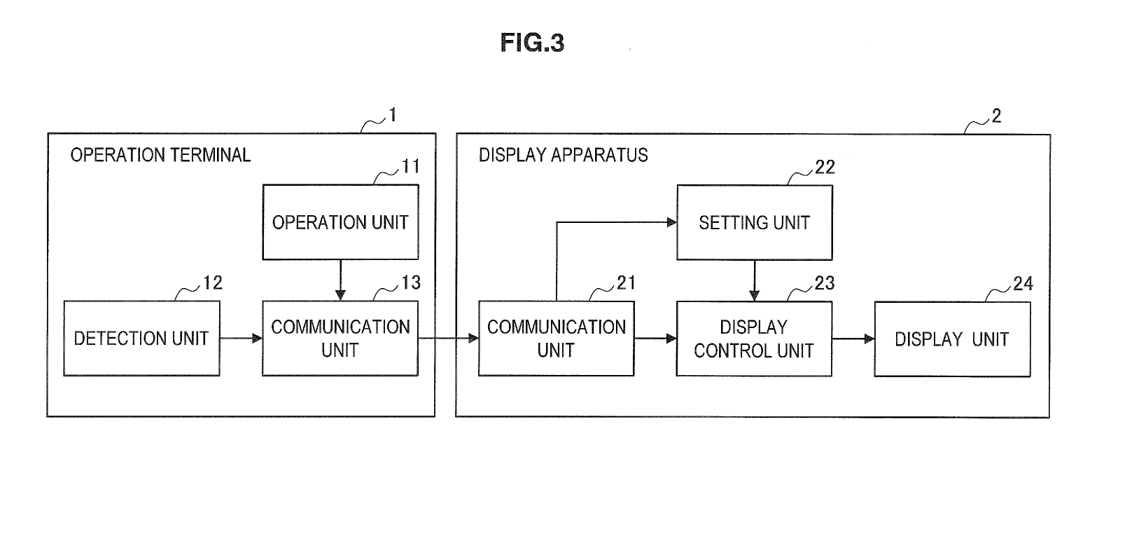

The overview of the display control processing according to the present embodiment has been described so far. Next, embodiments will be described in detail with reference to FIGS. 3 to 13.

### 2. EMBODIMENTS

### 2-1. First Embodiment

The display apparatus 2 (display control apparatus) primarily performs display control processing in the present embodiment. First of all, a configuration of the display control system according to the present embodiment will be described with reference to FIGS. 3 to 5.

### 2-1-1. Configuration

FIG. 3 is a block diagram illustrating a configuration of a display control system according to a first embodiment. FIG. 3 shows that the display control system according to the present embodiment includes an operation terminal 1 (direction indicator) and a display apparatus 2.

(Operation Terminal 1)

The operation terminal 1 is operated by a user, detects a movement of a user, and transmits the detection result to the display apparatus 2. The operation terminal 1 is implemented, for example, as a dedicated information processing apparatus, a smartphone, a tablet terminal, a mobile phone terminal, a portable music player, a portable video processing apparatus, or a portable game console. The operation terminal 1 includes an operation unit 11, a detection unit 12, and a communication unit 13.

(Operation Unit 11)

The operation unit 11 functions as an input unit that accepts a user operation such as selecting and deciding an image, text, and a button at a position of the displayed cursor 4. The operation unit 11 is implemented, for example, as a button, a touch panel, or a touch pad. The operation unit 11 shall be herein implemented as a button, and is also referred to as decision button. When the operation unit 11 is implemented as a button, the operation unit 11 accepts an operation perpendicularly performed on the plane of the operation terminal 1 on which the operation unit 11 is installed. FIG. 1 shows, for example, that the operation unit 11 accepts the operation of pushing the button down in the vertical direction when the plane of the operation terminal 1 on which the operation unit 11 is installed is parallel with the ground. The operation unit 11 generates operation information indicating the accepted user operation, and then outputs the generated operation information to the communication unit 13.

(Detection Unit 12)

The detection unit 12 has a function of detecting a change amount of the indicated direction 3 of the operation terminal 1 in the yaw direction 5 and the pitch direction 6, and a rotational angle (roll angle) in the roll direction 7 with the indicated direction 3 used as an axis. The detection unit 12 is implemented, for example, as an acceleration sensor or a gyro sensor. The detection unit 12 outputs, to the communication unit 13, change amount information indicating the detected change amount in the yaw direction 5 and the pitch direction 6, and roll angle information indicating the detected roll angle.

(Communication Unit 13)

The communication unit 13 is a communication module that transmits data to and receives data from an external apparatus. The communication unit 13 wirelessly communicates with an external apparatus directly or via a network access point in a scheme such as a wireless local area network (LAN), Wireless Fidelity (Wi-Fi) (registered trademark), infrared communication, and Bluetooth (registered trademark). The communication unit 13 according to the present embodiment transmits the operation information output from the operation unit 11, and the change amount information and roll angle information output from the detection unit 12 to the display apparatus 2.

(Display Apparatus 2)

The display apparatus 2 displays an image on the basis of the information received from the operation terminal 1. The display apparatus 2 is implemented, for example, as a television receiver, a display, a notebook PC, a smartphone, a tablet terminal, a mobile phone terminal, a portable video processing apparatus, or a portable game console. The display apparatus 2 includes a communication unit 21, a setting unit 22, a display control unit 23, and a display unit 24.

(Communication Unit 21)

The communication unit 21 is a communication module that transmits data to and receives data from an external apparatus. The communication unit 21 wirelessly communicates with an external apparatus directly or via a network access point in a scheme such as a wireless LAN, Wi-Fi (registered trademark), infrared communication, and Bluetooth (registered trademark). The communication unit 21 according to the present embodiment has a function of a reception unit that receives, from the operation terminal 1, information indicating a change amount of the indicated direction 3, and information indicating a roll angle with the indicated direction 3 used as an axis. The communication unit 21 receives change amount information and roll angle information from the operation terminal 1. The communication unit 21 further receives operation information indicating a user operation from the operation terminal 1. The communication unit 21 then outputs the received information to the setting unit 22 and the display control unit 23.

(Setting Unit 22)

The setting unit 22 has a function of setting an initial angle. The initial angle represents a roll angle of the operation terminal 1 in an initial state. For example, the setting unit 22 sets, as the initial angle, the roll angle as illustrated in FIG. 1 at which the plane of the operation terminal 1 on which the operation unit 11 is installed is parallel or substantially parallel with the ground. Additionally, let us assume herein that the roll angle at which the plane is kept parallel with the ground is 0 degrees. The setting unit 22 sets the initial angle at 0 degrees, allowing the display control unit 23 discussed below to realize a change in the speed gain corresponding to a change in the roll angle from the horizontal state (0 degrees), in which the operation terminal 1 shall be usually used.

In addition, the setting unit 22 may set, as the initial angle, the roll angle at which a changing speed of the roll angle exceeds a threshold (second threshold), on the basis of the roll angle information received from the operation terminal 1 through the communication unit 21. Specifically, the setting unit 22 sets, as the initial angle, the roll angle at which the operation terminal 1 goes through a sudden change in the roll direction 7, assumes that a user starts a twirling operation at this angle, and then detects the twirling operation. While a user is operating the operation terminal 1, the roll direction 7 may vary from 0 degrees because of a postural change of the user or an unintentional movement of the user's hand. In that case, the user does not intend to adjust the speed gain. Thus, it is desired that the speed gain be not changed. The setting unit 22 sets, as the initial angle, the roll angle at which the operation unit 1 goes through a sudden change in the roll direction 7, thereby preventing such a change in the speed gain based on an unintentional movement of a user.

The setting unit 22 may also set, as the initial angle, the roll angle at which a change amount of the roll angle has remained below a threshold (third threshold) for a predetermined time. Specifically, when the roll angle has not experienced a big change for a predetermined time, the setting unit 22 assumes that a user is using the operation terminal 1 in that state as a basic posture, and then sets the roll angle in that state as the initial angle. For example, while a user is using the operation terminal 1 in a lying posture, the operation terminal 1 is used in a rotated state from the beginning. Accordingly, the setting unit 22 sets the rotational angle as the initial angle. This allows the display control unit 23 to prevent a change in the speed gain in the basic posture and to realize a change in the speed gain according to a twirling operation from the basic posture. Additionally, the setting unit 22 may set the initial angle as soon as a predetermined time has passed, or may also gradually change the initial angle with the lapse of time after a predetermined time has passed.

(Display Control Unit 23)

The display control unit 23 has a function of moving the cursor 4 (object) displayed on the display unit 24 in accordance with a change amount of the indicated direction 3 of the operation terminal 1. Specifically, when the change amount of the indicated direction 3 is large, the display control unit 23 moves the cursor 4 much in the corresponding direction. When the amount of the indicated direction 3 is small, the display control unit 23 moves the cursor 4 a little in the corresponding direction.

Let us here assume that when the roll angle of the operation terminal 1 is the same as the initial angle, the speed gain is “1,” which namely means that the ratio of the movement of the cursor 4 to the change amount of the operation terminal 1 in the yaw direction 5 and the pitch direction 6 is “1.” When the speed gain is “1,” the display control unit 23 directly reflects a movement of a user in the movement of the cursor 4. Meanwhile, when the speed gain falls short of “1,” the display control unit 23 reduces a movement of a user, and then reflects the reduced movement of the user in the movement of the cursor 4. For example, even though the change amounts are the same, the movement amount of the cursor 4 at a speed gain of “0.25” is a quarter of the movement amount of the cursor 4 at a speed gain of “1.”

The display control unit 23 also has a function of changing a change amount of the cursor 4 corresponding to a change amount of the indicated direction 3 on the basis of the roll angle in the roll direction 7 with the indicated direction 3 used as an axis. More specifically, the display control unit 23 changes the speed gain on the basis of the difference between the roll angle and the initial angle. Accordingly, a user twirls the operation terminal 1 with a wrist motion to change the roll angle, so that the user can freely and easily change the speed gain.

The change will be more specifically described. As the difference between the initial angle set by the setting unit 22 and the roll angle grows bigger, the display control unit 23 to reduce the movement amount of the cursor 4 corresponding to the change amount more. More specifically, as a twirling operation of a user rotates the operation terminal 1 more in the roll direction 7, the display control unit 23 lowers the speed gain more. A user twirls the operation terminal 1, so that the user reduces the speed gain without moving the cursor 4. Such adjustment for a speed gain reduces an amount of an accidental movement caused by a movement of a hand, allowing a user to easily select a small object such as a text link.

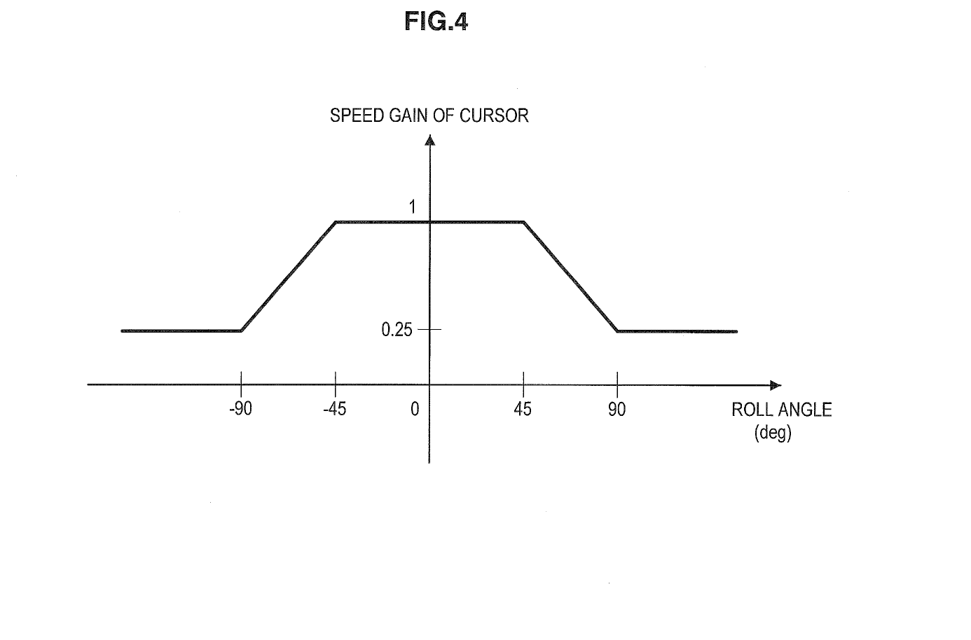

When the difference between the initial angle set by the setting unit 22 and the roll angle exceeds a threshold (first threshold), the display control unit 23 may reduce the movement amount of the cursor 4 corresponding to the change amount. Specifically, when a user twirls the operation terminal 1 by a given angle or more, the display control unit 23 lowers the speed gain. This allows the display control unit 23 to prevent the speed gain from changing due to a postural change of a user and an unintentional twirling operation. Such a relationship between a roll angle and a speed gain will be described below with reference to FIG. 4.

FIG. 4 is an explanatory diagram illustrating a relationship between a roll angle and a speed gain in display control processing according to the first embodiment. FIG. 4 illustrates the relationship between the roll angle and the speed gain at an initial angle of 0 degrees. FIG. 4 shows that the display control unit 23 keeps a speed gain of “1” while the roll angle remains between −45 and 45 degrees, that is, until the difference between the roll angle and the initial angle exceeds 45 degrees (first threshold). FIG. 4 also shows that as the difference grows bigger, which means that the operation unit 1 rotates more, the display control unit 23 lowers the speed gain while the roll angle remains between −90 and −45 degrees or 45 and 90 degrees, that is, after the difference between the roll angle and the initial angle exceeds 45 degrees. FIG. 4 further shows that when the roll angle is −90 degrees or less, or 90 degrees or more, which means that the difference between the roll angle and the initial angle exceeds a predetermined value (90 degrees), the display control unit 23 does not lower the speed gain thereafter, but keeps a constant value of “0.25.” This can prevent the speed gain from being excessively lowered. Additionally, values of 45, −45, 90 degrees, and “1” and “0.25” are merely illustrative. Any other values can also be used.

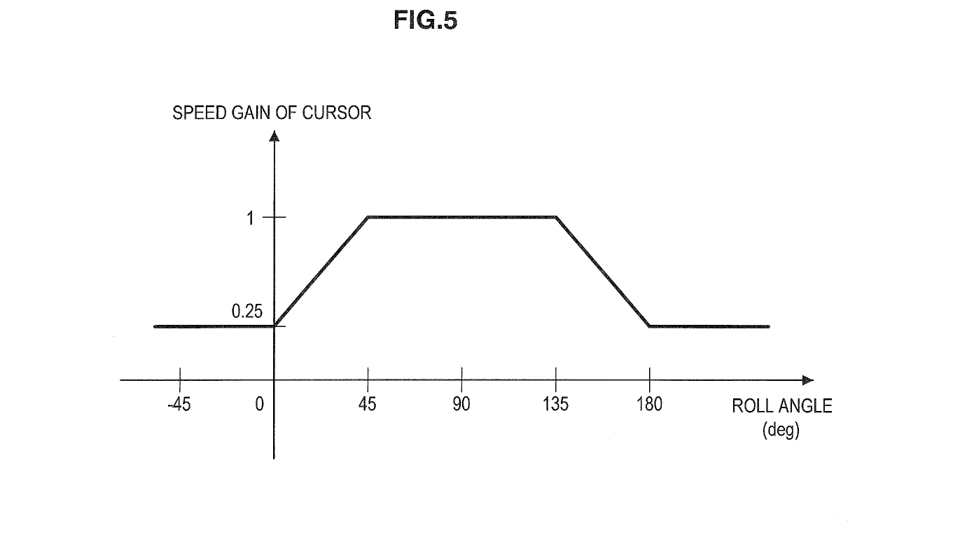

As discussed above, when the roll angle has not experienced a big change for a predetermined time, the setting unit 22 sets the roll angle at this point as the initial angle. The relationship between the speed gain and the roll angle when the setting unit 22 sets the initial angle at a value other than 0 degrees will be described below with reference to FIG. 5.

FIG. 5 is an explanatory diagram illustrating a relationship between the roll angle and the speed gain in the display control processing according to the first embodiment. FIG. 5 illustrates the relationship between the speed gain and the roll angle when the setting unit 22 sets the initial angle at a value of 90 degrees because the roll angle has remained about 90 degrees for a predetermined time. FIG. 5 shows that the display control unit 23 performs the same speed gain control illustrated in FIG. 4 around an initial angle of 90 degrees. Specifically, the display control unit 23 sets the initial angle at 90 degrees, and then keeps a speed gain of “1” while the roll angle remains between 45 and 135 degrees, that is, until the difference between the roll angle and the initial angle exceeds 45 degrees (first threshold). FIG. 5 also shows that as the difference grows bigger, which means that the operation unit 1 rotates more, the display control unit 23 lowers the speed gain while the roll angle remains between 0 and 45 degrees or 135 and 180 degrees, that is, after the difference between the roll angle and the initial angle exceeds 45 degrees. FIG. 5 further shows that when the roll angle is 0 degrees or less, or 180 degrees or more, which means that the difference between the roll angle and the initial angle exceeds a predetermined value (90 degrees), the display control unit 23 does not lower the speed gain thereafter, but keeps a constant value of “0.25.”

The display control unit 23 can adjust the speed gain in this way on the basis of a change in the roll angle from the initial angle set by the setting unit 22. This allows the display control unit 23 to prevent a change in the speed gain in a basic posture of about 90 degrees as illustrated in FIG. 5, and to realize a change in the speed gain responding to a twirling operation from the basic posture. The adjustment for a speed gain as illustrated in FIG. 5 can apply when the setting unit 22 sets an angle at the time of a sudden change in the roll angle as the initial angle.

The display control unit 23 may also change the appearance of the cursor 4 on the basis of the roll angle. As the difference between the roll angle and the initial angle grows bigger, for example, the display control unit 23 shrinks the cursor 4 more. This makes the cursor 4 smaller as the speed gain is lowered, allowing a user to perform a more delicate operation and to easily point a small object. To the contrary, while the difference between the roll angle and the initial angle is small, the cursor 4 remains big, so that the visibility is secured.

It shall be herein described that the cursor 4 is an object whose movement is controlled by the display control unit 23, but the present technology is not limited thereto. As discussed in a modified example 2 below, the display control unit 23 may, for example, control a movement of focus. The display control unit 23 may also control a movement of a cursor in a textural environment in addition to a movement of a so-called mouse cursor. Moreover, the display control unit 23 may control a scroll amount of screen scrolling or a size of a scroll gauge in accordance with the roll angle.

The display control unit 23 further performs various display control such as selecting/deciding an image or text at a position of the displayed cursor 4 on the basis of the operation information received by the communication unit 21.

(Display Unit 24)

The display unit 24 has a function of displaying (playing back) data of an image (data of a still image/data of a moving image) under the control of the display control unit 23. The display unit 24 is implemented, for example, as a liquid crystal display (LCD) or an organic light-emitting diode (OLED). The display unit 24 according to the present embodiment displays and moves the cursor 4 under the control of the display control unit 23.

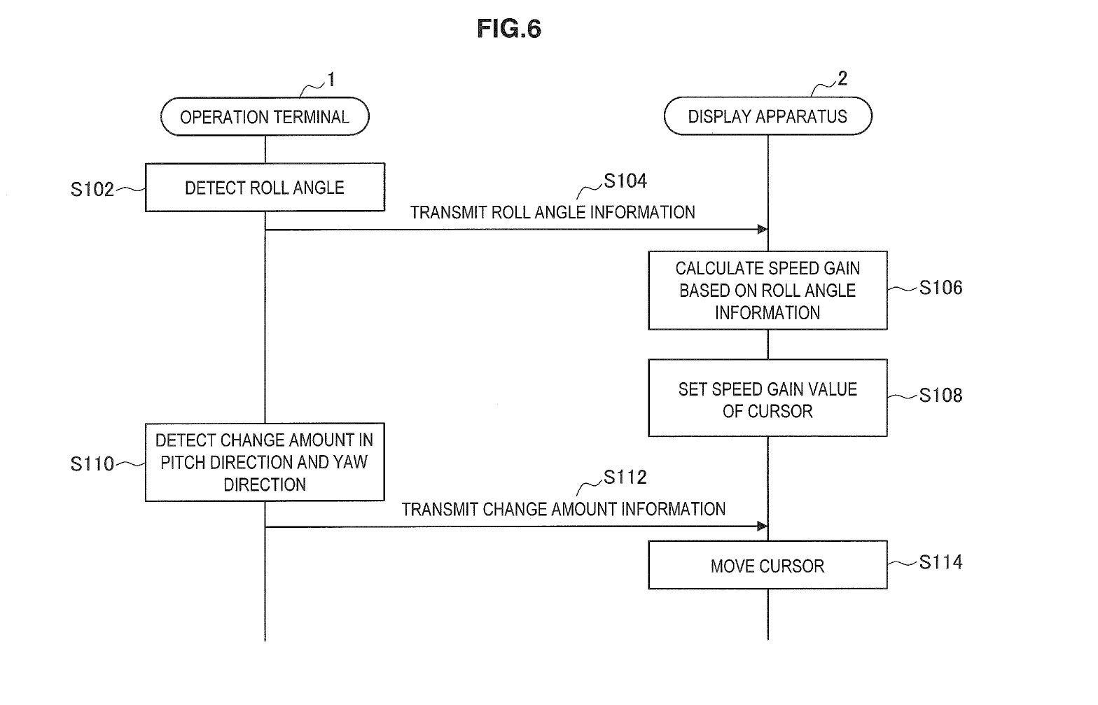

The configuration of the display control system according to the present embodiment has been described so far. Next, operational processing of the display control system according to the present embodiment will be described with reference to FIG. 6.

### 2-1-2. Operational Processing

FIG. 6 is a sequence diagram illustrating an operation of the display control system according to the first embodiment. FIG. 6 shows that the operation terminal 1 detects the roll angle in step S102. More specifically, the detection unit 12 detects the rotational angle of the operation terminal 1 in the roll direction 7 with an acceleration sensor or a gyro sensor, and then generates roll angle information.

In step S104, the communication unit 13 of the operation terminal 1 transmits the roll angle information output from the detection unit 12 to the display apparatus 2.

Next, in step S106, the display apparatus 2 calculates a speed gain on the basis of the roll angle information received from the operation terminal 1. More specifically, the display control unit 23 calculates a speed gain on the basis of the difference between the roll angle of the operation terminal 1 indicated by the roll angle information and the initial angle set by the setting unit 22. As described above with reference to FIGS. 4 and 5, the display control unit 23 calculates a speed gain of “1” until the difference between the roll angle and the initial angle exceeds 45 degrees, lowers the speed gain in accordance with the difference while the difference remains between 45 and 90 degrees, and calculates a speed gain of “0.25” when the difference exceeds 90 degrees.

In step S108, the display apparatus 2 sets a speed gain value of the cursor 4. More specifically, the display control unit 23 sets the value calculated in step S106 as the speed gain.

Next, in step S110, the display apparatus 2 detects the change amount in the pitch direction 6 and the yaw direction 5. More specifically, the detection unit 12 detects the change amount of the indicated direction 3 of the operation terminal 1 in the pitch direction 6 and the yaw direction 5 with an acceleration sensor or a gyro sensor, and then generates change amount information.

In step S112, the communication unit 13 of the operation terminal 1 transmits the change amount information output from the detection unit 12 to the display apparatus 2.

In step S114, the display apparatus 2 moves the cursor 4. More specifically, the display control unit 23 moves the cursor 4 by an amount according to the speed gain set in step S110 and the change amount information received by the communication unit 21 from the operation terminal 1. For example, when the speed gain is “1,” the display control unit 23 directly reflects a movement of a user in a movement of the cursor 4. Meanwhile, when the speed gain falls short of “1,” the display control unit 23 reduces a movement of a user and then reflects the reduced movement of the user in a movement of the cursor 4. Accordingly, the display apparatus 2 allows for a dynamic operation of the cursor 4 when the speed gain is “1.” When the speed gain is, for example, “0.25,” the display apparatus 2 allows a user to perform a delicate operation to easily point a small object.

The operational processing of the display control system according to the present embodiment has been described so far.

### 2-1-3. Advantageous Effects

As described above, according to the present embodiment, when a speed gain can be easily changed, it becomes possible to reduce an accidental movement caused by an unintentional movement of a user's hand to enhance the operability. More specifically, the display control system according to the present embodiment allows for adjustment for a speed gain in accordance with a rotating operation in the roll direction 7, which has not usually used before. Accordingly, a user roughly brings the cursor 4 near an object, and then adjusts the speed gain to decide the final position, so that the user can easily point a small object while dynamically moving the cursor 4 on a wide screen.

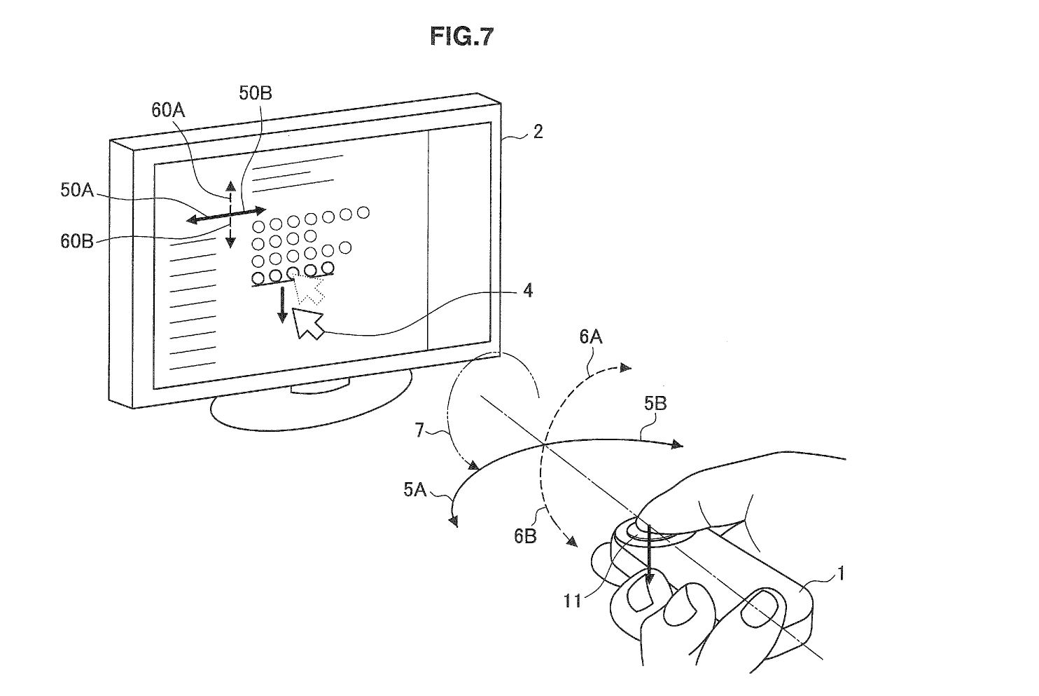

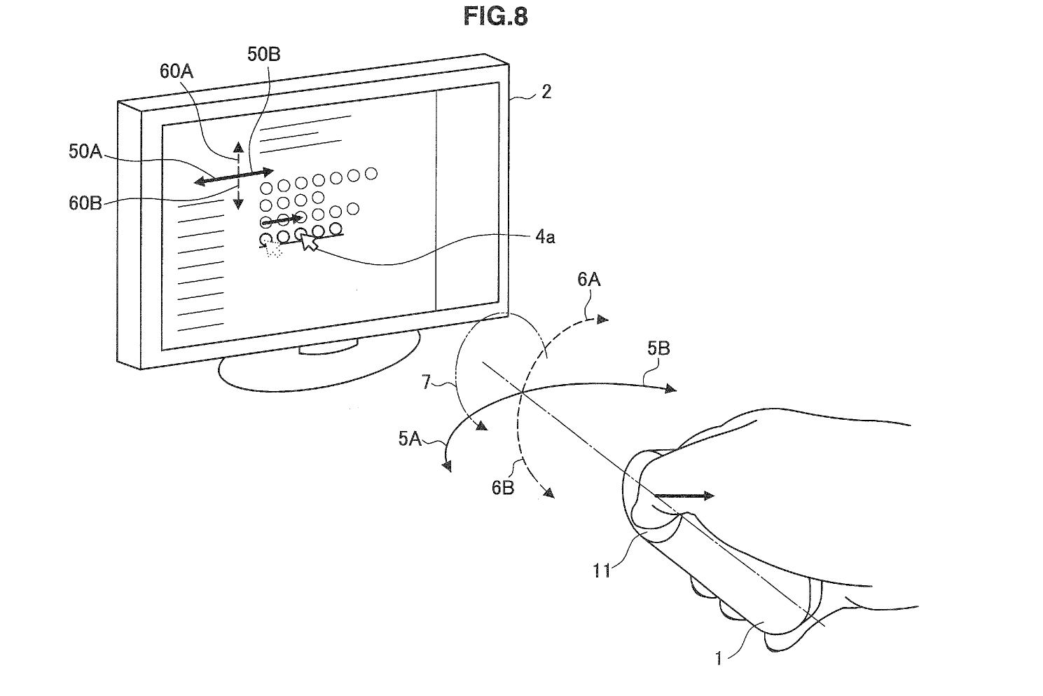

When the operation unit 11 is a device such as a button that is perpendicularly pushed down, the display control system according to the present embodiment can counteract the influence of failure in the deciding operation. It will be described below with reference to FIGS. 7 and 8 that the display control system according to the present embodiment counteracts the influence of failure in the deciding operation.

Each of FIGS. 7 and 8 is a diagram for describing an advantageous effect of the display control system according to the first embodiment. FIG. 7 shows that once the plane on which the operation unit 11 is installed is horizontally kept and a button is pushed down, the operation terminal 1 moves in the pitch direction 6B. Accordingly, the cursor 4 also moves in the Y direction 60B by accident. The same thing occurs in a preliminary operation in which the button has not yet been pushed down. FIG. 7 shows that when an object is short in the Y direction 60 like a text link, the accidental movement caused by the operation of pushing the button down sometimes moves the cursor 4 out of the object range, resulting in the failure in the deciding operation.

According to the present embodiment, however, a user lowers the speed gain to decide the final position, so that the user operates the deciding operation with the operation terminal 1 rotated in the roll direction 7. As illustrated in FIG. 8, when the button is pushed down in this state, the operation terminal 1 moves in the yaw direction 5B and an accidental movement occurs in the X direction 50B. Thus, when an object is long in the X direction 50 like a text link, there are fewer risks that an accidental movement caused by the operation of pushing the button down moves the cursor 4 out of the object range. The same thing occurs in a preliminary operation in which the button has not yet been pushed down. In this way, the display control system according to the present embodiment uses it that a user twirls a wrist to decide the final position, so that the display control system according to the present embodiment can counteract the influence of failure in the deciding operation.

FIG. 8 further shows that when the operation terminal 1 is rotated in the roll direction 7, the display control system according to the present embodiment displays a smaller cursor 4a than the cursor 4 illustrated in FIG. 7. This allows a user to operate the small cursor 4a more delicately at a lowered speed gain, so that the influence of failure in the deciding operation is further counteracted. When the operation terminal 1 is rotated in the roll direction 7, the display control system according to the present embodiment may reduce the scroll amount and enlarge the display of the scroll gauge to allow a user to perform a delicate scrolling operation.

The advantageous effects of the display control system according to the present embodiment have been so far. Modified examples of the present embodiment will be described below.

### 2-1-4. Modified Example 1

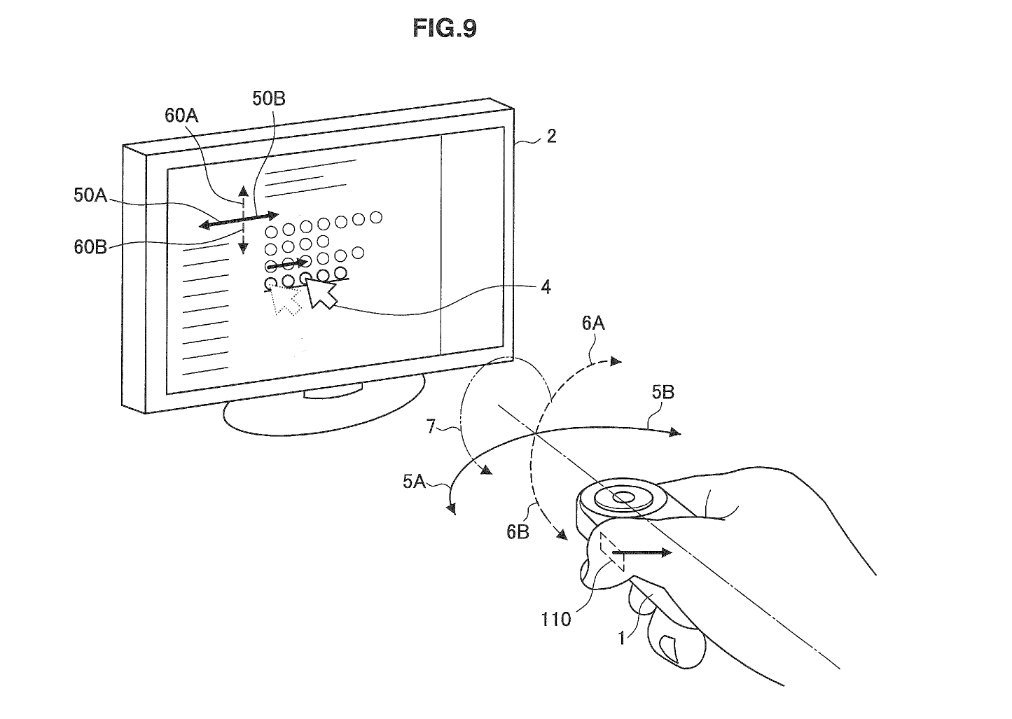

First, a display control system according to a modified example 1 will be described with reference to FIG. 9. According to the present modified example, arrangement of the decision button can counteract the influence of failure in the deciding operation.

FIG. 9 is a diagram for describing the display control system according to the modified example 1. FIG. 9 shows that an operation terminal 1 according to the modified example 1 includes an operation unit 110 on the side. Thus, as illustrated in FIG. 9, when the operation unit 110 is pushed down in a state of 0 degrees, the pushing operation moves the operation terminal 1 in the yaw direction 5B and an accidental movement occurs in the X direction 50B. Accordingly, when an object is long in the X direction 50 like a text link, there are fewer risks that the accidental movement caused by the operation of pushing the button down moves the cursor 4 out of the object range. The display control system according to the present modified example can counteract the influence of failure in the deciding operation in this way.

FIG. 9 is a diagram for describing the display control system according to the modified example 1. FIG. 9 shows that the operation terminal 1 according to the modified example 1 includes the operation unit 110 on the side. When the plane on which the operation unit 110 is installed is vertical or substantially vertical, a setting unit 22 according to the present modified example sets the initial angle at 0 degrees, as illustrated in FIG. 9. The operation unit 110 then accepts an input operation perpendicularly performed on the side of the operation terminal 1 on which the operation unit 110 is installed.

As illustrated in FIG. 9, when the operation unit 110 is pushed down in a state of 0 degrees, the pushing operation moves the operation terminal 1 in the yaw direction 5B and an accidental movement occurs in the X direction 50B. Accordingly, when an object is long in the X direction 50 like a text link, there are fewer risks that the accidental movement caused by the operation of pushing the button down moves the cursor 4 out of the object range. The display control system according to the present modified example can counteract the influence of failure in the deciding operation in this way.

### 2-1-5. Modified Example 2

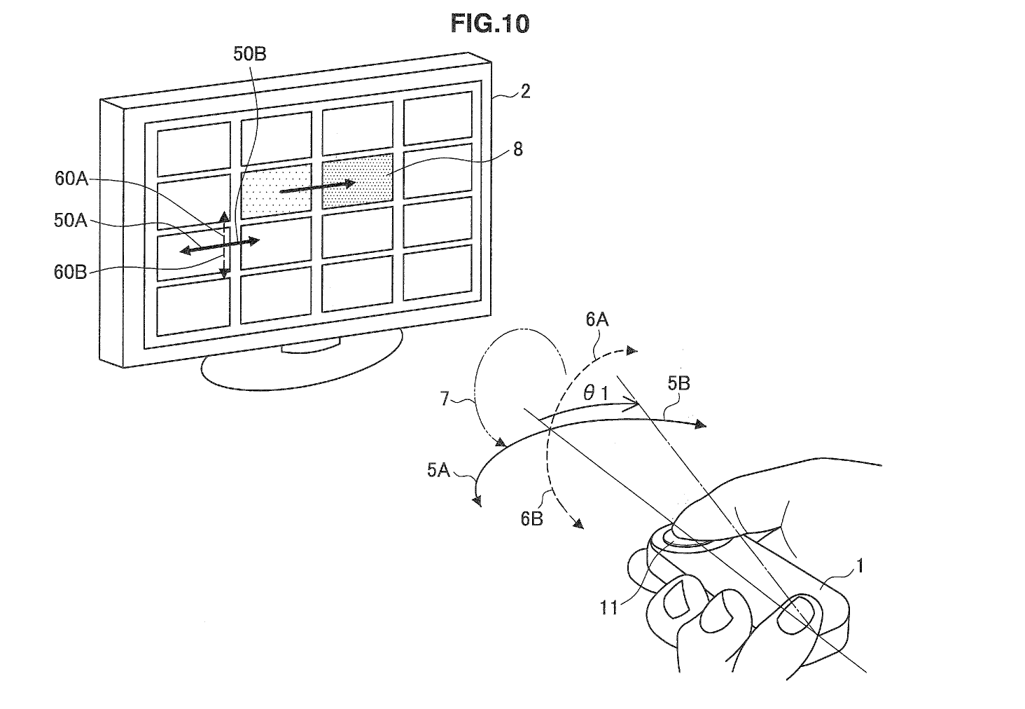

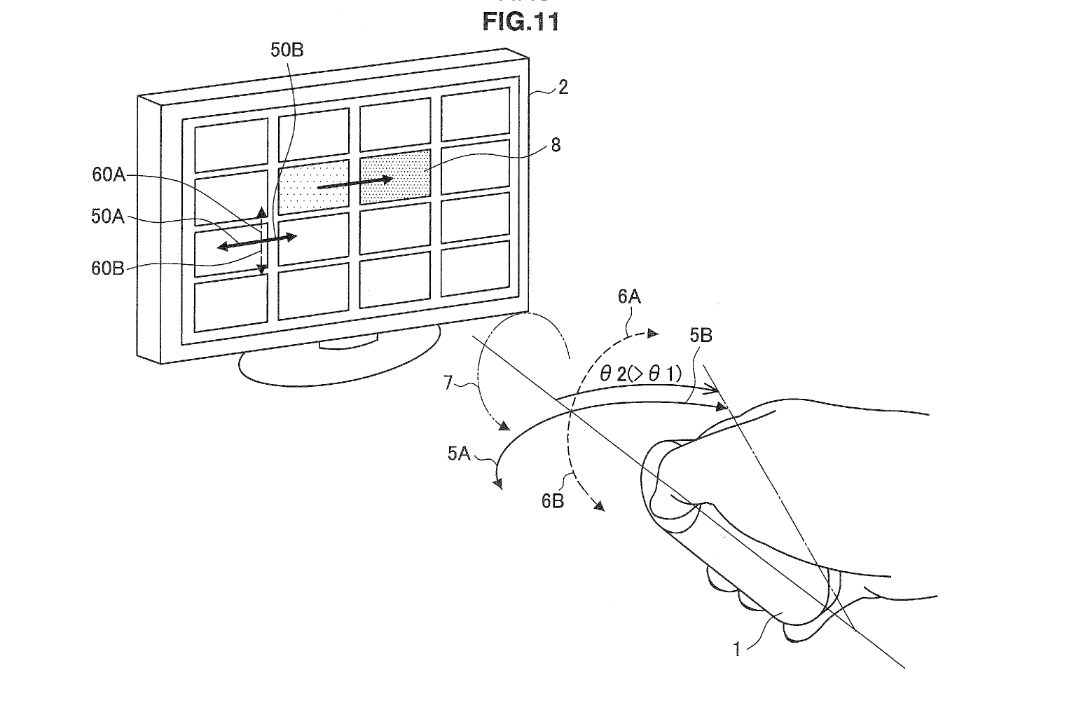

Next, a display control system according to a modified example 2 will be described with reference to FIGS. 10 and 11. According to the present modified example, it is possible to adjust a speed gain of a focus movement.

Each of FIGS. 10 and 11 is a diagram for describing the display control system according to the modified example 2. FIG. 10 shows that a change in the postural angle of the operation terminal 1 in the pitch direction 6 and the yaw direction 5 causes the display apparatus 2 to move focus 8 to a cell in the corresponding direction. Although the setting unit 22 can also set a given initial angle in the present modified embodiment, let the initial angle be 0 degrees here. As illustrated in FIG. 10, when a user changes an angle of the operation terminal 1 in the yaw direction 5B from the initial angle by θ₁, the display apparatus 2 shall move the focus 8 to the neighboring cell in the X direction 50B.

The display apparatus 2 also adjusts the speed gain in accordance with the roll angle of the operation terminal 1 in the present modified example. More specifically, the display control unit 23 reduces a movement amount of the focus 8 corresponding to a change amount of the indicated direction 3 in accordance with the difference between the initial angle set by the setting unit 22 and the roll angle. As described for the cursor 4 with reference to FIGS. 4 and 5, the display apparatus 2 according to the present modified example adjusts the speed gain. That is, when the initial angle and the roll angle exceed thresholds, the display apparatus 2 lowers the speed gain. Thus, as illustrated in FIG. 11, when an operation of twirling a wrist lowers the speed gain, θ₂ larger than θ₁ is used as an angle change amount in the yaw direction 5B for moving the focus 8 to the neighboring cell in the X direction 50B.

As described above, the display control system according to the present modified example can adjust the speed gain of a focus movement in accordance with the roll angle of the operation terminal 1.

The modified examples of the present embodiment have been described so far

### 2-2. Second Embodiment

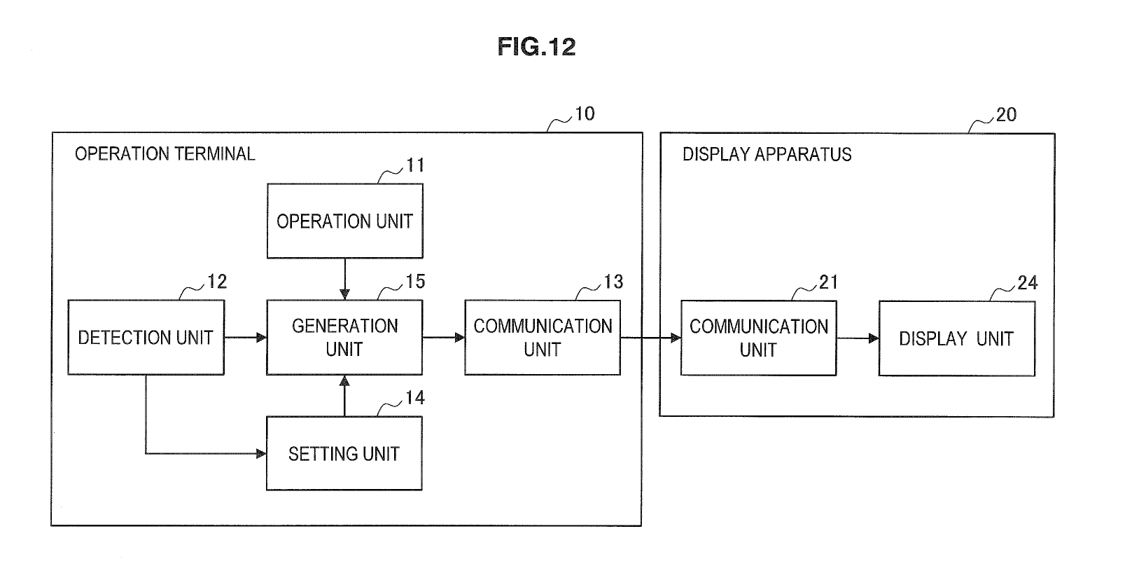

In the present embodiment, an operation terminal 10 (display control signal generating apparatus) primarily performs display control processing. First of all, a configuration of a display control system according to the present embodiment will be described with reference to FIG. 12.

### 2-2-1. Configuration

FIG. 12 is a block diagram illustrating a configuration of a display control system according to a second embodiment. FIG. 12 shows that the display control system according to the present embodiment includes an operation terminal 10 and a display apparatus 20.

(Operation Terminal 10)

The operation terminal 10 is operated by a user, generates a display control signal on the basis of a detection result of a user operation, and transmits the generated display control signal to the display apparatus 20. The operation terminal 10 includes an operation unit 11, a detection unit 12, a communication unit 13, a setting unit 14, and a generation unit 15.

(Operation Unit 11)

The operation unit 11 according to the present embodiment has the function described in the first embodiment, generates operation information, and then outputs the generated operation information to the generation unit 15

(Detection Unit 12)

The detection unit 12 according to the present embodiment has the function described in the first embodiment, and outputs change amount information and roll angle information to the setting unit 14 and the generation unit 15.

(Setting Unit 14) The setting unit 14 according to the present embodiment has a function of setting an initial angle like the setting unit 22 described in the first embodiment.

As illustrated in FIG. 1 for the first embodiment, for example, when the plane of the operation terminal 10 on which the operation unit 11 is installed is parallel with the ground, the setting unit 14 according to the present embodiment sets the roll angle as the initial angle. In addition, as in the first embodiment, when a changing speed of the roll angle exceeds a threshold (second threshold), the setting unit 14 according to the present embodiment may set the roll angle at that point as the initial angle on the basis of the roll angle information output from the detection unit 12. Furthermore, as in the first embodiment, when a change amount of the roll angle has remained below a threshold (third threshold) for a predetermined time, the setting unit 14 according to the present embodiment may set the roll angle at that point as the initial angle.

(Generation Unit 15)

The generation unit 15 according to the present embodiment has the same function as the function of the display control unit 23 described in the first embodiment. More specifically, the generation unit 15 has a function of generating a display control signal that requests the cursor 4 (object) displayed on the display unit 24 to be moved in accordance with the change amount detected by the detection unit 12. The display control signal generated by the generation unit 15 will also be referred to as cursor movement requesting signal below.

The generation unit 15 generates a cursor movement signal in which the movement amount of the cursor 4 corresponding to the change amount is changed, on the basis of the roll angle detected by the detection unit 12. More specifically, the generation unit 15 changes the speed gain on the basis of the difference between the roll angle and the initial angle. The generation unit 15 then generates a cursor movement requesting signal in which the movement amount is increased or decreased in accordance with the speed gain. Thus, a user can freely and easily change the speed gain by changing the roll angle through an operation of twirling the operation terminal 10 with a wrist motion.

The change will be more specifically described. The generation unit 15 generates a cursor movement signal in which the movement amount of the cursor 4 corresponding to the change amount is reduced more as the difference between the initial angle set by the setting unit 14 and the roll angle grows bigger. More specifically, as a twirling operation of a user rotates the operation terminal 10 in the roll direction 7 more, the generation unit 15 lowers the speed gain more. A user can reduce the speed gain without moving the cursor 4 through a twirling operation. This adjustment for a speed gain allows a user to easily select a small object such as a text link because an amount of an accidental movement caused by a movement of a hand grows smaller.

When the difference between the initial angle set by the setting unit 14 and the roll angle exceeds a threshold (first threshold), the generation unit 15 may generate a cursor movement signal in which the movement amount of the cursor 4 corresponding to the change amount is reduced. More specifically, when a user twirls the operation terminal 10 by a given angle or more, the generation unit 15 lowers the speed gain. This allows the generation unit 15 to prevent the speed gain from changing due to a postural change or an unintentional twirling operation of a user. The relationship between the roll angle and the speed gain has been already described with reference to FIGS. 4 and 5, so that the detailed description will be herein omitted.

As described in the first embodiment, the cursor 4 is not an only object whose movement is controlled by the generation unit 15 through a display control signal. For example, the generation unit 15 may also generate a display control signal for controlling focus, a so-called mouse cursor, a cursor in a textural environment, and screen scrolling.

The generation unit 15 generates a display control signal on the basis of the operation information output from the operation unit 11, the display control signal requesting various display for selecting/deciding an image or text at a position of the displayed cursor 4.

The generation unit 15 outputs the generated display control signal to the communication unit 13.

(Communication Unit 13)

The communication unit 13 according to the present embodiment has the function described in the first embodiment, and transmits the display control signal output by the generation unit 15 to the display apparatus 20.

(Display Apparatus 20)

The display apparatus 20 displays an image on the basis of the information received from the operation terminal 10. The display apparatus 20 includes a communication unit 21 and a display unit 24.

(Communication Unit 21)

The communication unit 21 according to the present embodiment has the function described in the first embodiment, and outputs the display control signal received from the operation unit 10 to the display unit 24.

(Display Unit 24)

The display unit 24 according to the present embodiment has the function described in the first embodiment, and displays a screen on the basis of the display control signal output from the communication unit 21.

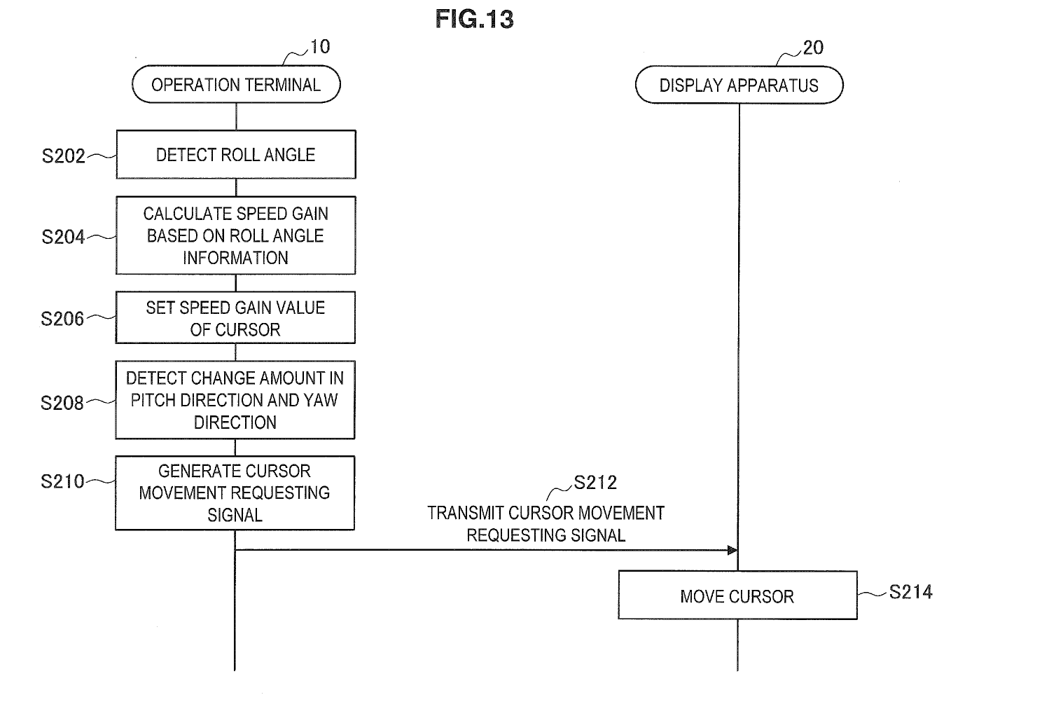

The configuration of the display control system according to the present embodiment has been described so far. Next, operational processing of the display control system according to the present embodiment will be described with reference to FIG. 13.

### 2-2-2. Operational Processing

FIG. 13 is a sequence diagram illustrating an operation of the display control system according to the second embodiment. FIG. 13 shows that the operation terminal 10 detects the roll angle in step S202. More specifically, the detection unit 12 detects the rotational angle of the operation terminal 10 in the roll direction 7 with an acceleration sensor or a gyro sensor, and then generates roll angle information.

In step S204, the operation terminal 10 calculates a speed gain on the basis of the roll angle information. More specifically, the generation unit 15 calculates a speed gain on the basis of the difference between the roll angle of the operation terminal 10 indicated by the roll angle information output by the detection unit 12 and the initial angle set by the setting unit 14. For example, as described in the first embodiment with reference to FIGS. 4 and 5, the generation unit 15 calculates “1” until the difference between the roll angle and the initial angle exceeds 45 degrees. When the difference remains between 45 and 90 degrees, the generation unit 15 lowers the speed gain in accordance with the difference. When the difference exceeds 90 degrees, the generation unit 15 calculates “0.25.”

Next, in step S206, the operation terminal 10 sets a speed gain value of the cursor 4. More specifically, the generation unit 15 sets the value calculated in step S204 as the speed gain.

In step S208, the operation terminal 10 detects the change amount in the pitch direction 6 and the yaw direction 5. More specifically, the detection unit 12 detects the change amount of the indicated direction 3 of the operation terminal 10 in the pitch direction 6 and the yaw direction 5 with an acceleration sensor or a gyro sensor, and then generates change amount information.

In step S210, the operation terminal 10 generates a cursor movement requesting signal. More specifically, the generation unit 15 generates a cursor movement requesting signal that requests the cursor 4 to be moved by an amount according to the speed gain set in step S206 and the change amount information output by the detection unit 12 in step S208. For example, when the speed gain is “1,” the generation unit 15 generates a cursor movement requesting signal that directly reflects a movement of a user in a movement of the cursor 4. Meanwhile, when the speed gain falls short of “1,” the generation unit 15 generates a cursor movement requesting signal that reduces a movement of a user and then reflects the reduced movement of the user in a movement of the cursor 4. The operation terminal 10 hereby allows for a dynamic operation of the cursor 4 when the speed gain is “1.” When the speed gain is, for example, “0.25,” the operation terminal 10 allows a user to perform a delicate operation for easily pointing a small object.

Next, in step S212, the communication unit 13 of the operation terminal 10 transmits the cursor movement requesting signal generated by the generation unit 15 to the display apparatus 20.

In step S214, the display unit 24 of the display apparatus 20 then moves the cursor 4 on the basis of the cursor movement requesting signal received by the communication unit 21 from the operation terminal 10.

The operational processing of the display control system according to the present embodiment has been described so far.

The advantageous effects according to the present embodiment are the same as the advantageous effects in the first embodiment, so that the detailed description will be herein omitted. The modified examples 1 and 2 described in the first embodiment can also apply to the present embodiment, yet the detailed description will be herein omitted.

### 3. CONCLUSION

As described above, the display control system according to an embodiment of the present disclosure can reduce an accidental movement caused by an unintentional movement of a user's hand to enhance the operability. Specifically, the display control system can change the speed gain in accordance with the roll angle to reduce an accidental movement caused by an unintentional movement of a user's hand and enhance the operability.

A user can easily and freely change the speed gain by changing the roll angle through an operation of twirling a wrist. Accordingly, a user roughly brings the cursor 4 near an object, and then adjusts the speed gain by twirling a wrist to decide the final position. This allows the user to easily point a small object while dynamically moving the cursor 4 on a wide screen.

The display control system according to an embodiment of the present disclosure can counteract the influence of failure in the deciding operation, which results from a movement of a hand when a button is pushed down for the deciding operation.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, the above-described embodiments have described examples where one of the operation terminal and the display apparatus has all the functions of the setting unit, the display control unit, or the generation unit included in the display control system. The present technology, however, is not limited thereto. For example, one of the operation terminal and the display apparatus may also separately have the functions. The display control system may also include other information processing apparatuses than the operation terminal and the display apparatus, and the other information processing apparatuses may have those functions and perform display control processing through communication with the operation terminal and the display apparatus.

As the relationship between the roll angle and the speed gain, the embodiments have described examples in which as the difference between the initial angle and the roll angle grows bigger, the speed gain is lowered more. However, the present technology is not limited thereto. The display control system may, for example, lower the speed gain more as the difference between the initial angle and the roll angle grows smaller. In this case, a user usually operates the operation terminal at a lower speed gain, and twirls a wrist to operate the operation terminal at a higher speed gain. This is effective when delicate pointing operations are performed most of the time and the cursor 4 is seldom moved dynamically on a wide screen.

It is described in the embodiments that when an object is long in the X direction 50 and short in the Y direction 60, the initial angle shall be 0 degrees and the movement amount of the cursor 4 corresponding to the change amount is reduced more as the difference between the initial angle and the roll angle grows bigger. However, the present technology is not limited thereto. The display control system may set the initial angle, or change the relationship between the roll angle and the speed gain in accordance with a shape of an object such as a link and an image displayed on a screen. For example, when an object displayed on a screen is long in the Y direction 60 and short in the X direction 50, the display control system may set the initial angle at 90 degrees, or lower the speed gain more as the difference between an initial angle of 0 degrees and the roll angle grows smaller. In both cases, a user horizontally keeps the operation terminal 1 and lowers the speed gain to decide the final position. Accordingly, an accidental movement caused by an operation of pushing a button down occurs in the Y direction 60. Since the object displayed on the screen is long in the Y direction 60, there are fewer risks that the accidental movement caused by the operation of pushing the button down moves the cursor 4 out of the object range.

It is also possible to make a computer program for causing hardware such as CPU, ROM, and RAM built in an information processing apparatus to execute the same functions as the configurations of the operation terminal 1 and the display apparatus 2, or the operation terminal 10 and the display apparatus 20. There is also provided a recording medium having the computer program recorded thereon.

Additionally, the present technology may also be configured as below:

(1) A display control apparatus including:

a display control unit configured to move an object displayed on a display unit in accordance with a change amount of an indicated direction of a direction indicator,

wherein the display control unit changes a movement amount of the object corresponding to the change amount on the basis of a rotational angle with the indicated direction used as an axis.

(2) The display control apparatus according to (1),

wherein the display control unit reduces the movement amount corresponding to the change amount as a difference between the rotational angle and an initial angle grows bigger.

(3) The display control apparatus according to (2),

wherein the display control unit reduces the movement amount corresponding to the change amount when the difference exceeds a first threshold.

(4) The display control apparatus according to (2) or (3), further including:

a setting unit configured to set the initial angle.

(5) The display control apparatus according to (4),

wherein the direction indicator includes an input unit that accepts an input from a user, and

wherein the setting unit sets, as the initial angle, an angle at which a plane of the direction indicator on which the input unit is installed is substantially horizontal.

(6) The display control apparatus according to (4),

wherein the setting unit sets, as the initial angle, the rotational angle at which a changing speed of the rotational angle exceeds a second threshold.

(7) The display control apparatus according to (4),

wherein the setting unit sets, as the initial angle, the rotational angle at which a change amount of the rotational angle has remained below a third threshold for a predetermined time.

(8) The display control apparatus according to (5),

wherein the input unit accepts an input operation perpendicularly performed on the plane of the direction indicator on which the input unit is installed.

(9) The display control apparatus according to (4),

wherein the direction indicator includes an input unit that accepts an input from a user,

wherein the setting unit sets, as the initial angle, an angle at which a plane of the direction indicator on which the input unit is installed is substantially vertical, and

wherein the input unit accepts an input operation perpendicularly performed on the plane of the direction indicator on which the input unit is installed.

(10) The display control apparatus according to any one of (1) to (7), further including:

a reception unit configured to receive information from the direction indicator, the information indicating the indicated direction and the rotational angle.

(11) A display control method including:

changing, on the basis of a rotational angle with an indicated direction of a direction indicator used as an axis, a movement amount of an object displayed on a display unit corresponding to a change amount of the indicated direction; and

moving the object in accordance with the change amount.

(12) A program for causing a computer to execute:

changing, on the basis of a rotational angle with an indicated direction of a direction indicator used as an axis, a movement amount of an object displayed on a display unit corresponding to a change amount of the indicated direction; and

moving the object in accordance with the change amount.

(13) A display control signal generating apparatus including:

a detection unit configured to detect a change amount of an indicated direction and a rotational angle with the indicated direction used as an axis; and

a generation unit configured to generate a display control signal for moving an object displayed on a display unit in accordance with the change amount detected by the detection unit,

wherein the generation unit generates the display control signal in which a movement amount of the object corresponding to the change amount is changed on the basis of the rotational angle detected by the detection unit.

(14) A display control signal generating method including:

detecting a change amount of an indicated direction and a rotational angle with the indicated direction used as an axis; and

generating a display control signal for moving an object displayed on a display unit in accordance the detected change amount, in which a movement amount of the object corresponding to the change amount is changed on the basis of the detected rotational angle.

(15) A program for causing a computer to execute:

detecting a change amount of an indicated direction and a rotational angle with the indicated direction used as an axis; and

generating a display control signal for moving an object displayed on a display unit in accordance the detected change amount, in which a movement amount of the object corresponding to the change amount is changed on the basis of the detected rotational angle.

(16) A display control system including:

a detection unit configured to detect a change amount of an indicated direction and a rotational angle with the indicated direction used as an axis; and

a display control unit configured to move an object displayed on a display unit in accordance with the change amount detected by the detection unit,

wherein the display control unit changes a movement amount of the object corresponding to the change amount on the basis of the rotational angle with the indicated direction used as an axis.

What is claimed is:

1. A display control apparatus comprising:
a display control unit configured to move an object displayed on a display unit in accordance with a change amount of an indicated direction of a direction indicator,
wherein the display control unit changes a movement amount of the object corresponding to the change amount on the basis of a rotational angle with the indicated direction used as an axis.

2. The display control apparatus according to claim 1,
wherein the display control unit reduces the movement amount corresponding to the change amount as a difference between the rotational angle and an initial angle grows bigger.

3. The display control apparatus according to claim 2,
wherein the display control unit reduces the movement amount corresponding to the change amount when the difference exceeds a first threshold.

4. The display control apparatus according to claim 2, further comprising:
a setting unit configured to set the initial angle.

5. The display control apparatus according to claim 4,
wherein the direction indicator includes an input unit that accepts an input from a user, and
wherein the setting unit sets, as the initial angle, an angle at which a plane of the direction indicator on which the input unit is installed is substantially horizontal.

6. The display control apparatus according to claim 4,
wherein the setting unit sets, as the initial angle, the rotational angle at which a changing speed of the rotational angle exceeds a second threshold.

7. The display control apparatus according to claim 4,
wherein the setting unit sets, as the initial angle, the rotational angle at which a change amount of the rotational angle has remained below a third threshold for a predetermined time.

8. The display control apparatus according to claim 5,
wherein the input unit accepts an input operation perpendicularly performed on the plane of the direction indicator on which the input unit is installed.

9. The display control apparatus according to claim 4,
wherein the direction indicator includes an input unit that accepts an input from a user,
wherein the setting unit sets, as the initial angle, an angle at which a plane of the direction indicator on which the input unit is installed is substantially vertical, and
wherein the input unit accepts an input operation perpendicularly performed on the plane of the direction indicator on which the input unit is installed.

10. The display control apparatus according to claim 1, further comprising:
a reception unit configured to receive information from the direction indicator, the information indicating the indicated direction and the rotational angle.

11. A display control method comprising:
changing, on the basis of a rotational angle with an indicated direction of a direction indicator used as an axis, a movement amount of an object displayed on a display unit corresponding to a change amount of the indicated direction; and
moving the object in accordance with the change amount.

12. A program for causing a computer to execute:
changing, on the basis of a rotational angle with an indicated direction of a direction indicator used as an axis, a movement amount of an object displayed on a display unit corresponding to a change amount of the indicated direction; and
moving the object in accordance with the change amount.

13. A display control signal generating apparatus comprising:
a detection unit configured to detect a change amount of an indicated direction and a rotational angle with the indicated direction used as an axis; and
a generation unit configured to generate a display control signal for moving an object displayed on a display unit in accordance with the change amount detected by the detection unit,
wherein the generation unit generates the display control signal in which a movement amount of the object corresponding to the change amount is changed on the basis of the rotational angle detected by the detection unit.

14. A display control signal generating method comprising:
detecting a change amount of an indicated direction and a rotational angle with the indicated direction used as an axis; and
generating a display control signal for moving an object displayed on a display unit in accordance the detected change amount, in which a movement amount of the object corresponding to the change amount is changed on the basis of the detected rotational angle.

15. A program for causing a computer to execute:
detecting a change amount of an indicated direction and a rotational angle with the indicated direction used as an axis; and
generating a display control signal for moving an object displayed on a display unit in accordance the detected change amount, in which a movement amount of the object corresponding to the change amount is changed on the basis of the detected rotational angle.

16. A display control system comprising:
a detection unit configured to detect a change amount of an indicated direction and a rotational angle with the indicated direction used as an axis; and
a display control unit configured to move an object displayed on a display unit in accordance with the change amount detected by the detection unit,
wherein the display control unit changes a movement amount of the object corresponding to the change amount on the basis of the rotational angle with the indicated direction used as an axis.
